(19) United States
(12) Patent Application Publication
(10) Pub. No.: US 2013/0268214 A1
(43) Pub. Date: Oct. 10, 2013

(54) PROBABILISTIC FATIGUE LIFE PREDICTION USING ULTRASONIC INSPECTION DATA CONSIDERING EIFS UNCERTAINTY

(71) Applicants: Xuefei Guan, Princeton, NJ (US); Jingdan Zhang, Plainsboro, NJ (US); Kai Kadau, Clover, SC (US); Shaohua Kevin Zhou, Plainsboro, NJ (US)

(72) Inventors: Xuefei Guan, Princeton, NJ (US); Jingdan Zhang, Plainsboro, NJ (US); Kai Kadau, Clover, SC (US); Shaohua Kevin Zhou, Plainsboro, NJ (US)

(73) Assignees: Siemens Aktiengesellschaft, Munich (DE); Siemens Corporation, Iselin, NJ (US)

(21) Appl. No.: 13/855,130

(22) Filed: Apr. 2, 2013

Related U.S. Application Data
(60) Provisional application No. 61/620,087, filed on Apr. 4, 2012.

(51) Int. Cl. G01N 29/44

(52) U.S. Cl. CPC G01N 29/4418
USPC 702/34

(57) ABSTRACT

A method for probabilistically predicting fatigue life in materials includes sampling a random variable for an actual equivalent initial flaw size (EIFS), generating random variables for parameters (ln C, m) of a fatigue crack growth equation

$$\frac{d a}{d N} = {C ( Δ K )}^{m}$$

from a multivariate distribution, and solving the fatigue crack growth equation using these random variables. The reported EIFS data is obtained by ultrasonically scanning a target object, recording echo signals from the target object, and converting echo signal amplitudes to equivalent reflector sizes using previously recorded values from a scanned calibration block. The equivalent reflector sizes comprise the reported EIFS data.

### CROSS REFERENCE TO RELATED UNITED STATES APPLICATIONS

This application claims priority from “Probabilistic Fatigue Life Prediction Using Ultrasonic Inspection Data Considering EIFS Uncertainty”, U.S. Provisional Application No. 61/620,087 of Guan, et al., filed Apr. 4, 2012, the contents of which are herein incorporated by reference in their entirety.

### TECHNICAL FIELD

This application is directed to methods for probabilistic fatigue life prediction using ultrasonic non-destructive examination (NDE) data.

### DISCUSSION OF THE RELATED ART

Fatigue crack propagation is a frequent seen failure cause for most brittle materials subject to stress load. For mission-critical structure components, fatigue crack flaws need to be identified and accurately quantified so that the components can be maintained to avoid catastrophic events. Nondestructive examination is one technique available for reliable damage identification. For large scale structural components, such as generator rotors and turbine blades, ultrasonic testing (UT) is commonly used due to its flexibility. The conversion from ultrasound raw data to physical flaw size usually involves multiple steps, including probe tuning, calibration, signal processing, and the final flaw size calculation. Due to the stochastic nature of flaws embedded in the target component, the physical flaw size has large variations for a given intensity of ultrasound response signal. In addition, the probability of detection introduces another uncertainty into the flaw size computation. Those uncertainties propagate through the life prediction model and can affect maintenance decision-making and may cause catastrophic results.

To calculate a fatigue crack growth and fatigue life, the equivalent initial flaw size (EIFS) is a useful variable that should be accurately and reliably quantified. In most realistic applications, a direct visual measurement is not available because actual flaws are usually embedded in the testing piece. Even if a flaw is on the surface, direct measurement may not be easily obtained due to the complex geometry of the system and its service condition. Therefore, ultrasonic inspection has become a practical way to obtain flaw information, particularly for embedded flaws. To estimate EIFS for fatigue crack growth and fatigue life calculation from ultrasonic inspection data, the method of distance gain sizing (DGS) is extensively used. Due to inherent variability of the flaws and in the ultrasonic testing mechanism, the actual EIFS and the reported EIFS obtained using DGS method have noticeable differences. In the worst cases, the ratio of the actual EIFS to the reported EIFS may be 5 or even higher.

Traditional fatigue life prediction using ultrasonic inspection data is usually a deterministic calculation. To compensate for uncertainties in the life evaluation process, many safety factors are employed to ensure a wide safe margin. Those safety factors depend on historical experiences and engineering judgment. For example, safety factors are used in the tress intensity factor calculation, to adjust the final fatigue life, and in the initial flaw size estimate. The concept of a safety factor is convenient to apply but the life prediction results are difficult to interpret. For example, a prediction of a remaining useful life of 2000 cycles does not necessarily mean the system will fail given that the load cycle reaches 2000. Another disadvantage of deterministic fatigue life prediction using safe factors is that the contribution of each uncertainty source is unknown. In addition, fatigue life predictions can sometimes be unrealistically conservative and result in unnecessarily frequent maintenance which increases the life-cycle cost. Recent research on fatigue life prediction is shifting from a traditional deterministic analysis to a probabilistic analysis by explicitly including all major sources of uncertainty using probabilistic modeling. Probabilistic studies usually include uncertainties from model choice, model parameter, and numerical evaluation. However, few studies have been reported to provide a systematical method for explicit uncertainty quantification for EIFS obtained from ultrasonic testing data using DGS method.

### SUMMARY

Exemplary embodiments of the invention as described herein generally include systems and methods for probabilistically quantifying uncertainties in fatigue life prediction. A probabilistic model according to an embodiment of the invention is used to correlate the reported EIFS and the actual EIFS size, based on historical rotor data and the distribution of the actual flaw size. The ratio of actual EIFS and reported EIFS is modeled using a Gamma distribution, which is suitable for a general use. Other uncertainties, such as model parameter uncertainty are explicitly included using Bayesian parameter estimation. A two-parameter Paris type of fatigue crack growth equation is adopted for fatigue crack growth trajectory and fatigue life prediction. Monte Carlo methods are used to evaluate the distribution of fatigue crack growth trajectory and fatigue life. A method according to an embodiment of the invention is demonstrated using a realistic example of a Cr—Mo—V generator rotor and the reported EIFS from ultrasonic testing data. A probabilistic life prediction method according to an embodiment of the invention can provide information such as fatigue life probability, which useful for decision making and life-cycle cost analysis.

According to an aspect of the invention, there is provided a method for probabilistically predicting fatigue life in materials, including sampling a random variable for an actual equivalent initial flaw size (EIFS), generating random variables for parameters of a fatigue crack growth equation from a multivariate distribution, and solving the fatigue crack growth equation using these random variables.

According to a further aspect of the invention, the method includes repeating the steps of sampling a random variable for the EIFS, generating random variables for parameters and solving the fatigue crack growth equation until convergence.

According to a further aspect of the invention, sampling a random variable for an actual equivalent initial flaw size (EIFS) includes sampling a random variable from a distribution for a ratio of the actual EIFS to a reported EIFS, and multiplying this ratio by the reported EIFS to obtain a random variable for the actual EIFS, where the distribution for a ratio of the actual EIFS to the reported EIFS is

$$f ( x \vert k , θ ) = \frac{{x}^{k - 1}}{Γ ( k ) {θ}^{k}} exp ( - \frac{x}{θ} ) ,$$

where x is the random variable for the ratio of the actual EIFS to the reported EIFS, k and θ are shape and scale parameters of the distribution, and Γ( ) is the Gamma function.

According to a further aspect of the invention, k and θ are determined from a maximum likelihood estimator using data for the actual EIFS and the reported EIFS.

According to a further aspect of the invention, sampling a random variable for an actual equivalent initial flaw size (EIFS) includes sampling a random variable from a distribution for the actual EIFS, where the distribution for the actual EIFS is

$$f ( y ) = \frac{1}{\hat{a} Γ ( k ) {θ}^{k}} \frac{{y}^{k - 1}}{{\hat{a}}^{k - 1}} exp ( - \frac{y}{\hat{a} θ} ) ,$$

where y is the random variable for the actual EIFS, â is the random variable for a reported EIFS, k and θ are shape and scale parameters of the distribution determined from experimental data, and Γ( ) is the Gamma function.

According to a further aspect of the invention, the fatigue crack growth equation is

$$\frac{d a}{d N} = {C ( Δ K )}^{m} ,$$

where a is a crack size, N is a number of load cycles, C and m are model parameters estimated from experimental data for which random variables are generated, and ΔK is a stress intensity factor range for one load cycle, where for an elliptically shaped crack, the stress intensity factor K of a point located at an angle λ with respect to a direction of an applied tensile stress σ is given by

$$K = M σ \sqrt{π a / Q} {( {sin}^{2} λ + {( \frac{a}{c} )}^{2} {cos}^{2} λ )}^{\frac{1}{4}} ,$$

where M is a location factor, a is the crack size and a minor axis length of the elliptically shaped crack and c is the major axis length of elliptically shaped crack,

$$Q = {Φ}^{2} - \frac{2}{3 π} ( \frac{σ}{{σ}_{ys}} )$$

is a flaw shape factor where

$$Φ = {\int }_{0}^{π / 2} \sqrt{1 - ( \frac{{c}^{2} - {a}^{2}}{{c}^{2}} ) {sin}^{2} λ} d λ$$

is an elliptical integral of the second kind and σ_{ys} is material yield strength.

According to a further aspect of the invention, the multivariate distribution is

$$p ( ln C , m , {σ}_{e} ) = \frac{1}{{σ}_{e}} {\prod }_{i = 1}^{n} \frac{1}{\sqrt{2 π} {σ}_{e}} exp [ - \frac{1}{2} {( \frac{ln C + m ln Δ {K}_{i} - {[ ln ( \frac{d a}{d N} ) ]}_{i}}{{σ}_{e}} )}^{2} ] ,$$

where σₑ is an error variable, and ln ΔKᵢ and [ln(da/dN)]ᵢ are i^{th} experimental data points from a total of n points.

According to a further aspect of the invention, reported EIFS data is obtained by ultrasonically scanning a target object, recording echo signals from the target object, and converting echo signal amplitudes to equivalent reflector sizes using previously recorded values from a scanned calibration block, where the equivalent reflector sizes comprise the reported EIFS data.

According to another aspect of the invention, there is provided a non-transitory program storage device readable by a computer, tangibly embodying a program of instructions executed by the computer to perform the method steps for probabilistically predicting fatigue life in materials.

According to another aspect of the invention, there is provided a system for probabilistically predicting fatigue life in materials, including an ultrasonic transducer, and a control program of instructions in signal communication with the ultrasonic transducer and executable by a computer tangibly embodied in one or more computer readable program storage devices that perform the method steps for probabilistically predicting fatigue life in materials, the method including sampling a random variable for an actual equivalent initial flaw size (EIFS), generating random variables for parameters of a fatigue crack growth equation from a multivariate distribution, and solving the fatigue crack growth equation using these random variables.

According to a further aspect of the invention, the system includes a calibration block having a plurality of artificial reflectors, the calibration block configured for being scanned by the ultrasonic transducer, where the ultrasonic transducer records ultrasonic echo signals from the artificial reflectors and for comparison with echo signals recorded from the target object.

### BRIEF DESCRIPTION OF THE DRAWINGS

FIGS. 1(a)-(b) illustrates the ratio of actual EIFS to reported EIFS as a function of the reported EIFS, and a histogram of the ratio of actual EIFS to reported EIFS with a Gamma distribution fit, according to an embodiment of the invention.

FIG. 2 illustrates the determination of an actual EIFS from a reported EIFS for an embedded elliptical crack geometry, according to an embodiment of the invention.

FIG. 3 shows an elliptically shaped crack, according to an embodiment of the invention.

FIG. 4 is a flow chart of an exemplary method for probabilistic fatigue life prediction using ultrasonic non-destructive examination (NDE) data, according to an embodiment of the invention.

FIG. 5 shows an embedded flaw identified by US inspection data, according to an embodiment of the invention.

FIG. 6 shows experimental data points, the median and the 95% bound fit for ln(da/dN)˜ln ΔK for Cr—Mo—V material at 500 F, according to an embodiment of the invention.

FIGS. 7(a)-(b) show several crack growth trajectory probability bound contours and the final fatigue life distribution in terms of total starts, according to an embodiment of the invention.

FIG. 8 is a block diagram of an exemplary computer system for implementing a method for probabilistic fatigue life prediction using ultrasonic non-destructive examination (NDE) data, according to an embodiment of the invention.

### DETAILED DESCRIPTION OF EXEMPLARY EMBODIMENTS

Exemplary embodiments of the invention as described herein generally include systems for probabilistic fatigue life prediction using ultrasonic non-destructive examination (NDE) data, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

As used herein, the term “image” refers to multi-dimensional data composed of discrete image elements (e.g., pixels for 2-dimensional images and voxels for 3-dimensional images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R or R⁷, the methods of the inventions are not limited to such images, and can be applied to images of any dimension, e.g., a 2-dimensional picture or a 3-dimensional volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

The conversion from ultrasonic testing data to a reported EIFS involves using a DGS method to convert the ultrasonic echo signal amplitudes to an equivalent reflector size, and (2) converting the equivalent reflector size to EIFS by assuming the flaw geometry. For a normal scanning process, a calibration block with the same material of the target system is used. The calibration block has artificial reflectors, such as flat bottom holes (FBH) perpendicular to the ultrasonic beam axis and side drill holes (SDH. The ultrasonic transducer scans the calibration block to record echo signals from the artificial reflectors and the values of the echo signal amplitudes are recorded for future use. Once the target system is scanned, the amplitude of each data point will be examined and interested points will be converted to equivalent reflector size using the previously recorded values from the calibration block. The conversion is made using the DGS method. EQ. (1) expresses the ultrasonic echo signal amplitude A_{FBH} from FBH in the far field:

$${A}_{FBH} ∝ \frac{{{A}_{0} ( b / s )}^{2}}{{( z / D )}^{2}} , \qquad ( 1 )$$

where A₀ is the probe's sensitivity, b is the FBH diameter (i.e., the equivalent reflector size), s is the probe diameter, z is the distance from the FBH to the probe surface, and D is the near field length of the probe. In practice, this relationship is plotted as a set of DGS curves. Each of the curves is characterized by b/s and the curve describes the change of A_{FBH}/A₀ vs. z/D. Those curves can represent any probe type regardless of its size, shape, beam angle, and frequency. With the knowledge of FBH calibration and its echo amplitude A_{FBH}, and the actual testing echo amplitude of a flaw, the flaw size in terms of the equivalent reflector size b can be calculated using this equation. The size calculated using a DGS method is referred to as the equivalent reflector size or reported size.

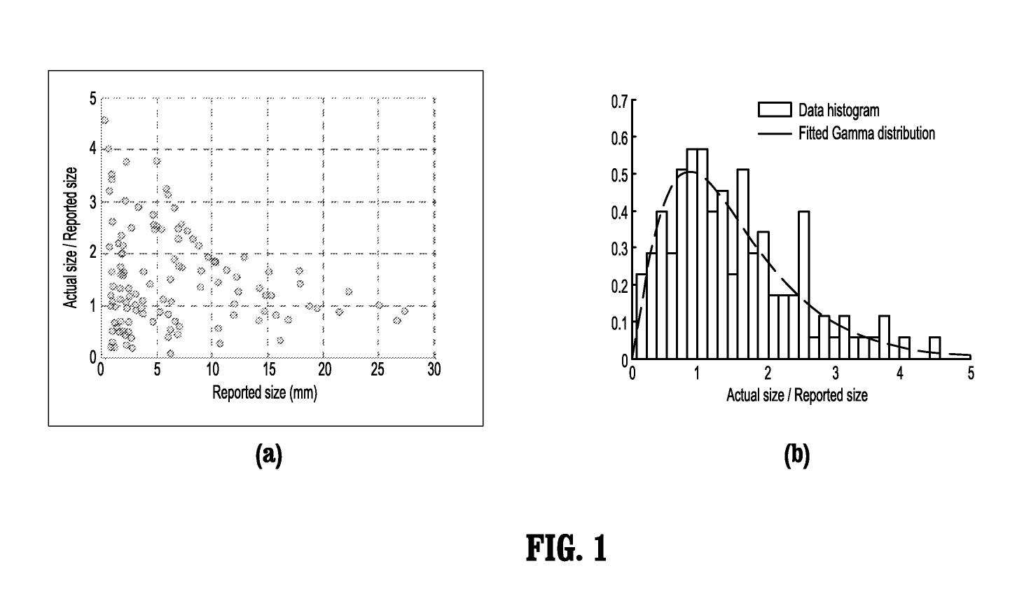

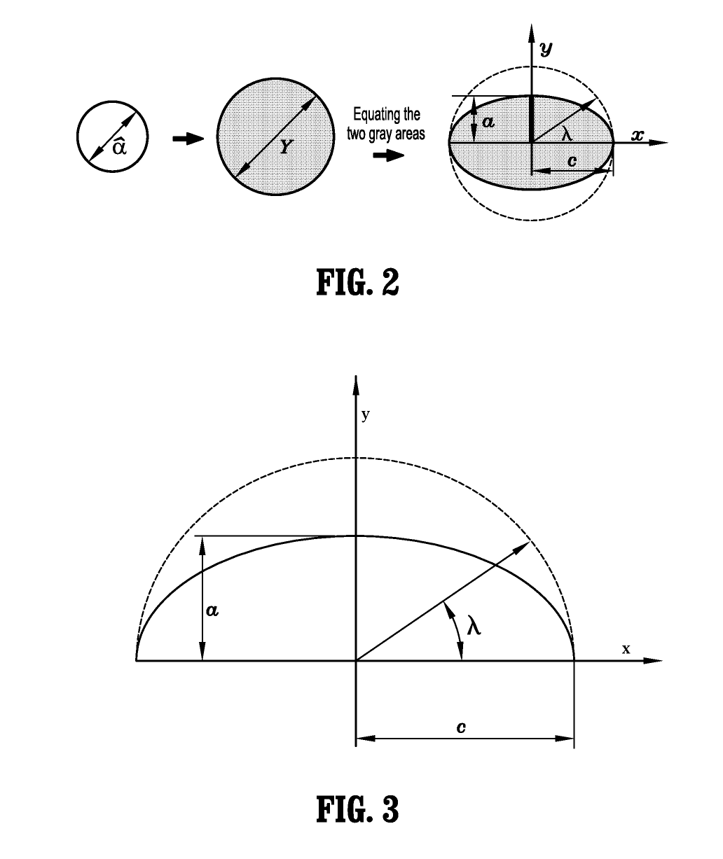

According to embodiments of the invention, a probabilistic treatment of the actual EIFS based on the reported EIFS is of interest. The data reported in R. Schwant and D. Timo, “Life Assessment of General Electric Large Steam Turbine Rotors”, in Life Assessment and Improvement of Turbo-Generator Rotors for Fossil Plants, R. Viswanathan, Editor, Pergamon Press: New York (1985), pp. 3.25-3.40, the contents of which are herein incorporated by reference in their entirety, provides a source of statistical relationships between the reported EIFS and the ratio of the actual EIFS to the reported EIFS. FIG. 1(a) illustrates the ratio of actual EIFS to reported EIFS as a function of the reported EIFS, using data values from Schwant, et al., and FIG. 1(b) depicts a histogram of the ratio of the actual EIFS to the reported EIFS with a Gamma distribution fit, using the data shown in FIG. 1(a). Denoting the uncertainty variable for the ratio as X, the value of the random variable as x∈R⁺, and the probability density function (PDF) as f( ) then the fitted Gamma PDF can be expressed as

$$X ∼ f ( x \vert k , θ ) = \frac{{x}^{k - 1}}{Γ ( k ) {θ}^{k}} exp ( - \frac{x}{θ} ) , \qquad ( 2 )$$

where k and θ are shape and scale parameters of the distribution, and Γ( ) is the Gamma function. According to embodiments of the invention, the two parameters can be obtained using a maximum likelihood estimator as k=2.3484 and θ=0.6397. Because the fit is based on the data collected from a broad range of ultrasonic inspection cases, it is not associated with any particular probes and can be used as a general probabilistic modeling of the ratio. Denote the uncertainty variable for the actual EIFS as Y and the deterministic reported EIFS (i.e., the equivalent reflector size b) as â. Then, the random variable for the actual EIFS is y=xâ and the PDF of the actual EIFS can be derived as

$$\begin{matrix}Y ∼ f ( y ) = {\int }_{x ∈ {R}^{+}} f ( y \vert x ) f ( x \vert k , θ ) d x \\ = {\int }_{x ∈ X} δ ( y - x \hat{a} ) f ( x \vert k , θ ) d x \\ = \frac{1}{\hat{a} Γ ( k ) {θ}^{k}} \frac{{y}^{k - 1}}{{\hat{a}}^{k - 1}} exp ( - \frac{y}{\hat{a} θ} ) ,\end{matrix} \qquad ( 3 )$$

where δ( ) is the Dirac delta function and the other variables are defined as before. Once the actual size is obtained, the EIFS can readily be computed by assuming the flaw geometry. For an embedded elliptical crack geometry, the conversion is illustrated in FIG. 2, which shows a circle of diameter â, the reported EIFS, on the left, a circle of diameter Y, actual EIFS, in the center, and an ellipse on the right whose area is the same as the circle of radius Y, where the EIFS is the minor axis length a of the elliptical shape. By equating the areas of the ellipse and the center circle of diameter Y, the major axis length c of the ellipse can be determined. With EQ. (3), a fatigue crack growth model can explicitly include the uncertainty from the EIFS estimation.

A fatigue crack growth model according to an embodiment of the invention will now be introduced. Ultrasonic testing is frequently used to examine flaws in large engineering systems, such as generator rotors and casings of a fossil plant, where those components are operated under a high temperature environment. For industrial applications, the Paris-type of fatigue crack growth equations are widely used due to their simple model format and limited number of required parameters. A general format of a two-parameter Paris' equation is expressed in the following equation:

$$\frac{d a}{d N} = {C ( Δ K )}^{m} , \qquad ( 4 )$$

where a is the crack size, N is the number of load cycles, C and m are model parameters estimated from experimental data, and ΔK is the stress intensity factor range during one load cycle. The actual EIFS obtained as illustrated in FIG. 2 can be used as an initial crack size. For an elliptically shaped crack, as shown in FIG. 3, the stress intensity factor K of a point located at an angle λ with respect to the direction of the applied tensile stress σ is given by

$$K = M σ \sqrt{π a / Q} {( {sin}^{2} λ + {( \frac{a}{c} )}^{2} {cos}^{2} λ )}^{1 / 4} , \qquad ( 5 )$$

where M is a location factor, a is the crack size, which is also the minor axis length of the semi-ellipse and c is the major axis length of the semi-ellipse, obtained as illustrated in FIG. 2. The factor

$$Q = {Φ}^{2} - \frac{2}{3 π} ( \frac{σ}{{σ}_{ys}} )$$

is the flaw shape factor where

$$Φ = {\int }_{0}^{\frac{π}{2}} \sqrt{1 - ( \frac{{c}^{2} - {a}^{2}}{{c}^{2}} ) {sin}^{2} λ} d λ$$

is an elliptical integral of the second kind and σ_{ys} is material yield strength. For a given a/c value, K takes its maximum value at λ=π/2. For general engineering evaluations, a/c usually takes a value of about 0.4. The factor M is about 1.0 for an embedded crack and about 1.21 for a surface crack.

According to an embodiment of the invention, given an actual EIFS a₀, model parameter (C, m), and material properties such as σ_{ys}, EQ. (4) can be solved as an ordinary differential equation to obtain a crack growth trajectory. Integration of dN from a₀ to the critical crack size a_{c} yields the fatigue life. By convention, (ln C, m) is usually used in the parameter estimation process instead of (C, m).

Model parameters (C, m) can be estimated from standard experimental testing data. It should be noted that estimation of the two parameters using one set of data obtained from one testing coupons should be carefully made. It can be challenging to find the parameter covariance matrix using a direct estimation such as linear regression on ln(da/dN)˜ln ΔK to obtain (ln C, m). Therefore, according to an embodiment of the invention, if one set of data is available, more robust estimation method can be applied, such as a Bayesian parameter estimation method. With no prior knowledge about (ln C, m) and the error variable σₑ, the posterior can be expressed as EQ. (6) using Bayes' theorem with a Gaussian likelihood:

$$p ( ln C , m , {σ}_{e} ) = \frac{1}{{σ}_{e}} {\prod }_{i = 1}^{n} \frac{1}{\sqrt{2 π} {σ}_{e}} exp [ - \frac{1}{2} {( \frac{ln C + m ln Δ {K}_{i} - {[ ln ( \frac{d a}{d N} ) ]}_{i}}{{σ}_{e}} )}^{2} ] , \qquad ( 6 )$$

where ln ΔKᵢ and [ln(da/dN)]ᵢ are the i^{th} experimental data points of a total of n points. Using methods such as a Markov chain Monte Carlo (MCMC) or slice-sampling, (ln C, m) and σₑ can be sampled from the posterior. By convention, the parameters (ln C, m) are treated as a multivariate normal variables. From the simulation samples, the mean and covariance matrix can be obtained. An overall process according to an embodiment of the invention is demonstrated with an example, below.

Uncertainties propagate through the fatigue crack growth model of EQ. (4). Methods exist for probabilistically evaluating the fatigue life and the crack growth trajectory. One such universal computation method is a simple Monte Carlo method, which is easy to implement but may be time-consuming. Another method is the inverse first order reliability method (FORM), which is efficient in terms of the required number of function evaluations. These two approaches are described and compared in X. Guan, J. He, R. Jha, and Y. Liu, “An efficient analytical Bayesian method for reliability and system response updating based on Laplace and inverse first-order reliability computations”, Reliability Engineering & System Safety, 97(1): pp. 1-13 (2012), the contents of which are herein incorporated by reference in their entirety.

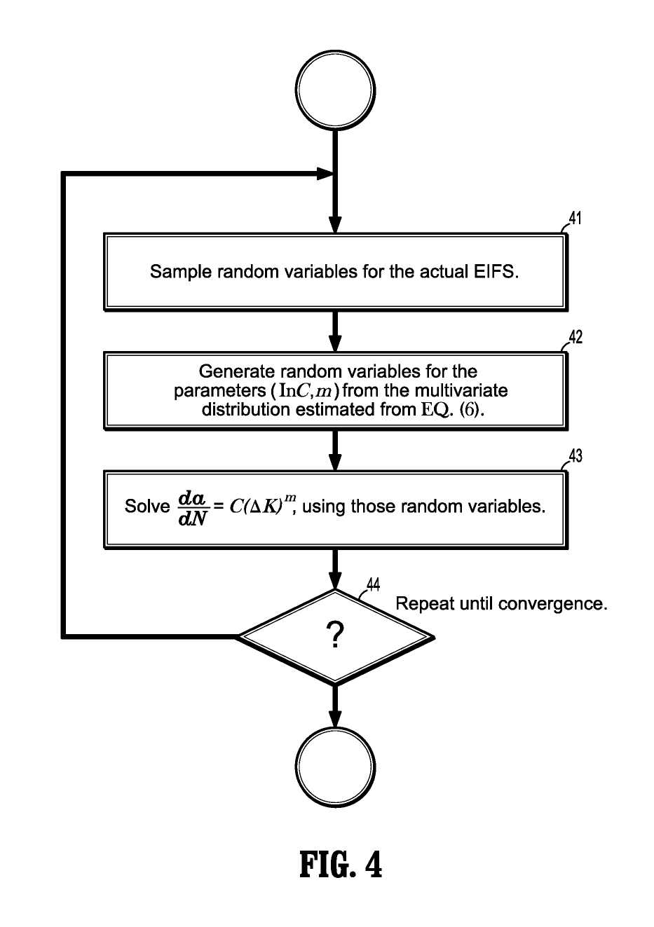

According to an embodiment of the invention, a universal simple Monte Carlo method is used, however, this choice is exemplary and non-limiting, and other methods, such as an inverse FORM, can be used in other embodiments of the invention. A flow chart of a Monte Carlo method according to an embodiment of the invention procedure is presented in FIG. 4, and begins at step 41 by sampling random variables for the actual EIFS. This can be done in two ways: (1) sampling a random variable from the distribution of EQ. (2),

$$f ( x \vert k , θ ) = \frac{{x}^{k - 1}}{Γ ( k ) {θ}^{k}} exp ( - \frac{x}{θ} ) ,$$

i.e., the ratio of the actual EIFS to the reported EIFS, and then multiplying this value by the reported EIFS to obtain a random instance of the actual EIFS; and (2) directly sampling a random variable from the distribution of EQ. (3),

$$f ( y ) = \frac{1}{\hat{a} Γ ( k ) {θ}^{k}} \frac{{y}^{k - 1}}{{\hat{a}}^{k - 1}} exp ( - \frac{y}{\hat{a} θ} ) ,$$

as the actual EIFS. These two choices are equivalent. A next step 42 is to generate random variables for the parameters (ln C, m) from the multivariate distribution estimated from EQ. (6). A third step 43 involves solving EQ. (4),

$$\frac{d a}{d N} = {C ( Δ K )}^{m} ,$$

using those random variables. Steps 41, 42, and 43 can be repeated from step 44 for a sufficiently large number of iterations until the result converges. Usually a simulation run of 10⁵-10⁶ iterations is sufficient for engineering purposes.

Forward integration of EQ. (4) produces a trajectory of crack size a vs. the applied number of cycles N. For each given (ln C, m) sampled from the distribution of EQ. (6), a trajectory can be obtained. By generating a large number of samples (ln C, m), a large number of crack size trajectories can be obtained. Therefore, given a number of starts N, e.g. 3000, the corresponding distribution of crack size a can be approximated, from which the failure probability at a given N can be calculated. For example, given N=3000, there is a distribution of the crack size a. By defining a failure size of, e.g., a_{c}=5 mm, meaning that a crack size larger than aₑ is considered a failure event, one can calculate the probability of Pr(a>5 mm) using the distribution of a, where the resulting probability is the failure probability.

The final result for the fatigue life prediction is a distribution. For a fatigue crack growth trajectory, the result is a time dependent distribution because at different number of cycles, the crack size distributes differently, and the overall crack growth trajectory forms a probability envelop.

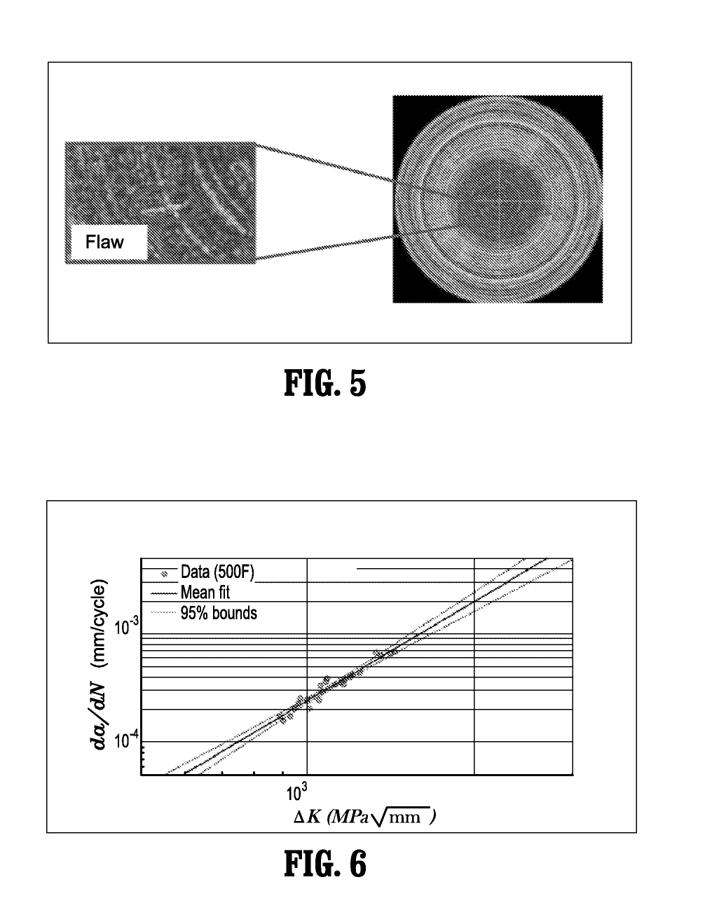

A method according to an embodiment of the invention can be demonstrated using a realistic example. The target system is a generator rotor segment made by Cr—Mo—V steel and operated at 500° F., and the ultrasonic field testing reported a 2.5 mm crack size length for an embedded elliptical flaw, shown in FIG. 5. To obtain the model parameter (ln C, m) in EQ. (4) under this service condition, experimental data reported in T. T. Shih and G. A. Clarke, “Effects of Temperature and Frequency on the Fatigue Crack Growth Rate Properties of a 1950 Vintage CrMoV Rotor Material”, in Fracture Mechanics, G. V. Smith, Editor American Society for Testing and Materials (1979), pp. 125-143, the contents of which are herein incorporated by reference in their entirety, is used to perform Bayesian parameter estimation using EQ. (6). FIG. 6 presents experimental data points for ln(da/dN)˜ln ΔK for Cr—Mo—V material at 500 F, the median and the 95% bound fit from a parameter distribution obtained using Bayesian parameter estimation.

The mean vector and covariance matrix for parameter (ln C, m) are μ=[−29.3493, 3.04371 and

$$Σ = [ \begin{matrix}1.4448 & - 0.2062 \\ - 0.2062 & 0.0294\end{matrix} ] ,$$

respectively obtained using MCMC simulations. The flaw is an embedded elliptical flaw with a/c=0.4. The loading block comprises 200 cycles of cold starts and 1000 cycles of hot starts. During cold starts, the maximum and minimum stresses are 700 MPa and 70 MPa, respectively. For hot starts, the maximum and minimum stresses are 500 MPa and 50 MPa, respectively. The critical crack size a_{c} is calculated by equating max(K)=K_{lc}, where K_{lc}=4934.3 MPa\sqrt{mm} is the critical stress intensity factor for the Cr—Mo—V material. In this case, a_{c}=13.11 mm. The yield strength for Cr—Mo—V material at 500° F. is σ_{ys}=569.2 MPa.

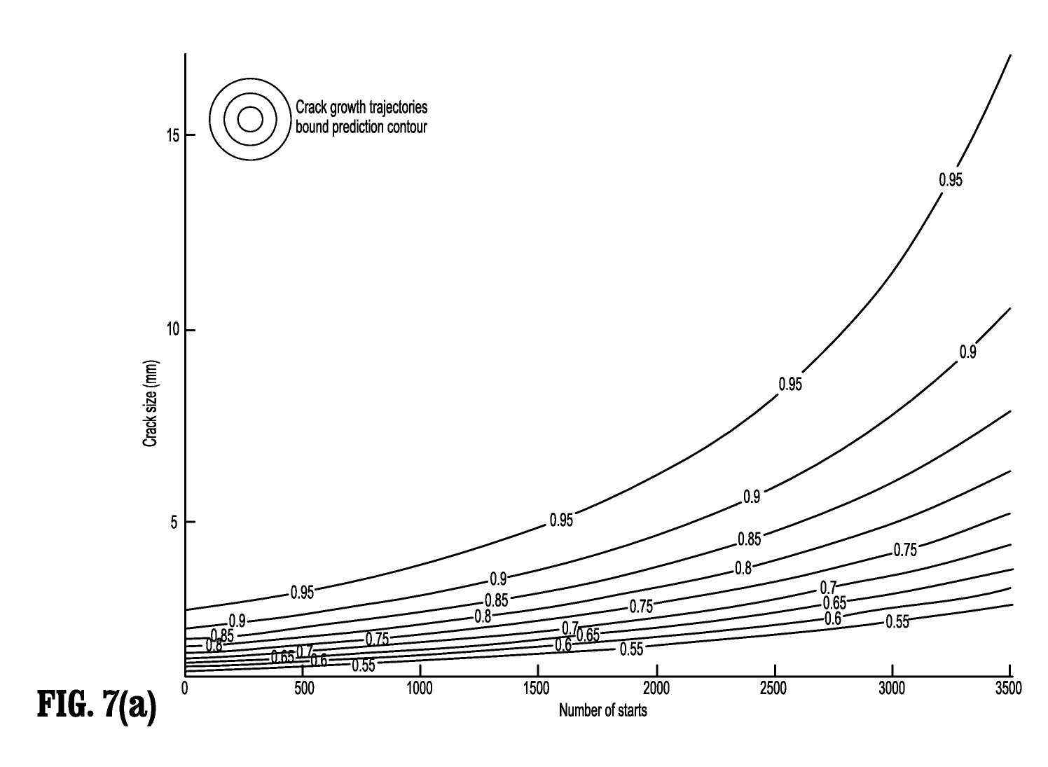

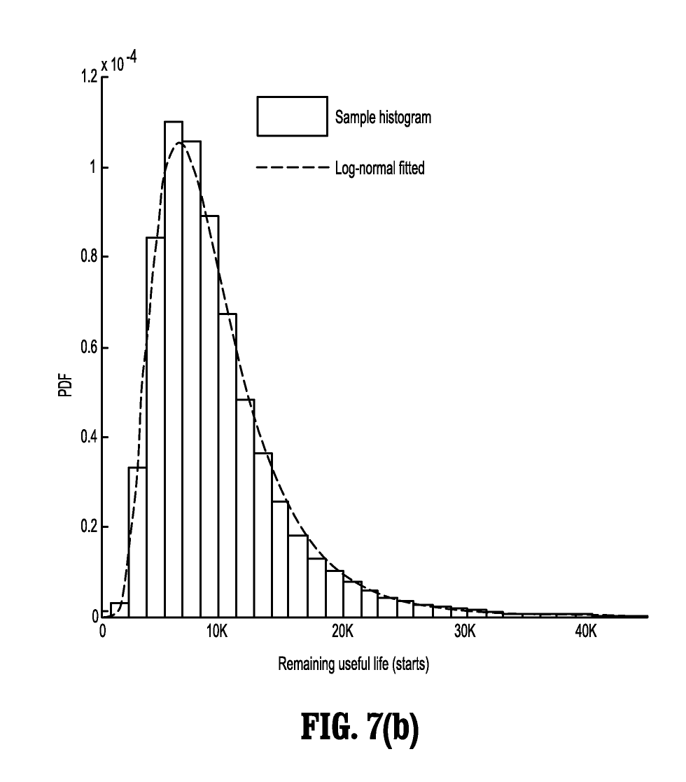

A linear damage accumulation rule is used for crack growth computation for each given loading block. The yield strength in shape factor Q for the Cr—Mo—V material at 500° F. is σ_{ys}=569.2 MPa. One hundred thousand iterations are performed using simple Monte Carlo simulations. FIG. 7(a) shows several crack growth trajectory probability bound contours as a function of number of starts, and FIG. 7(b) shows the final fatigue life distribution in terms of total starts. The curves in FIG. 7(a) are labeled by the probability of a crack size being less than a particular value at a given probability (e.g., 0.95) and number of starts N (e.g., 3000). For example, considering the 0.95 curve, if one draws a vertical at N=3000, the crack size is about 12 mm. This means that the crack size has a 0.95 probability of being less than 12 mm at N=3000.

The fatigue life prediction results can be interpreted in terms of probability. From the results of fatigue life shown in FIG. 7(b), the rotor has a probability of 0.9999 of having a remaining useful life greater than 1279 total starts, a probability of 0.999 of having a remaining useful life greater than 1870 total starts, and has a probability of 0.99 of having a remaining useful life larger than 2691 starts. Interpretation of crack length can also be made similarly from the results shown in FIG. 7(a). For example, the 0.95 contour line indicates that the crack size has a probability of 95% to be smaller than the value associated with the line.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

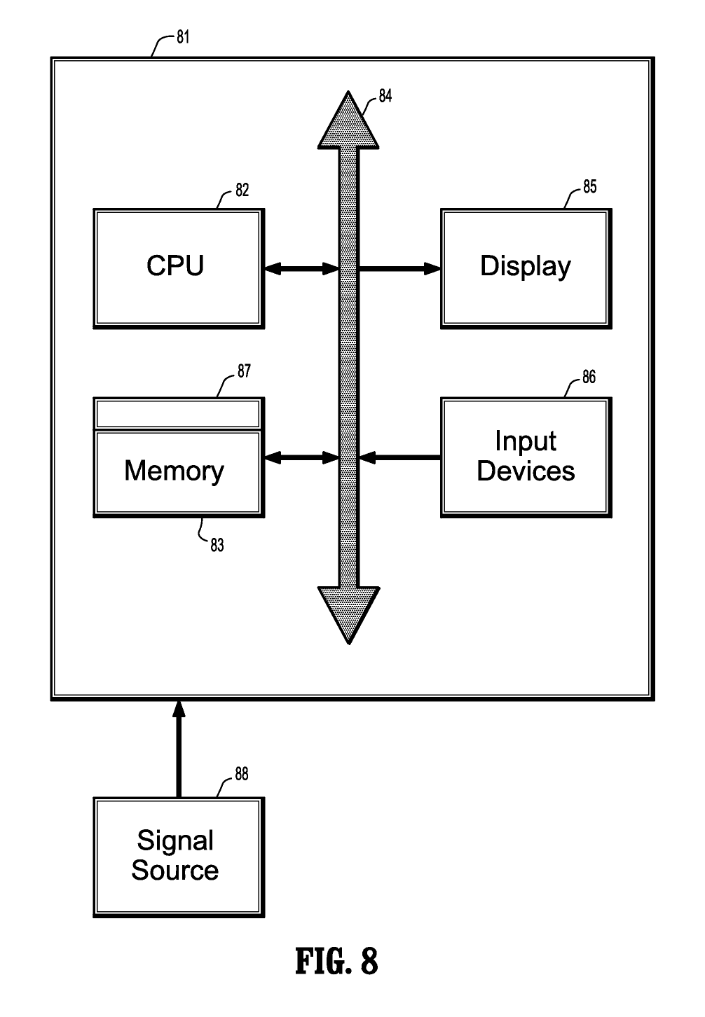

FIG. 8 is a block diagram of an exemplary computer system for implementing a method for probabilistic fatigue life prediction using ultrasonic non-destructive examination (NDE) data according to an embodiment of the invention. Referring now to FIG. 8, a computer system 81 for implementing the present invention can comprise, inter alia, a central processing unit (CPU) 82, a memory 83 and an input/output (I/O) interface 84. The computer system 81 is generally coupled through the I/O interface 84 to a display 85 and various input devices 86 such as a mouse and a keyboard. The support circuits can include circuits such as cache, power supplies, clock circuits, and a communication bus. The memory 83 can include random access memory (RAM), read only memory (ROM), disk drive, tape drive, etc., or a combinations thereof. The present invention can be implemented as a routine 87 that is stored in memory 83 and executed by the CPU 82 to process the signal from the signal source 88. As such, the computer system 81 is a general purpose computer system that becomes a specific purpose computer system when executing the routine 87 of the present invention.

The computer system 81 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to exemplary embodiments, those skilled in the art will appreciate that various modifications and substitutions can be made thereto without departing from the spirit and scope of the invention as set forth in the appended claims.

What is claimed is:

1. A method for probabilistically predicting fatigue life in materials, comprising the steps of:
sampling a random variable for an actual equivalent initial flaw size (EIFS);
generating random variables for parameters of a fatigue crack growth equation from a multivariate distribution; and
solving the fatigue crack growth equation using these random variables.

2. The method of claim 1, further comprising repeating said steps of sampling a random variable for the EIFS, generating random variables for parameters and solving the fatigue crack growth equation until convergence.

3. The method of claim 1, wherein sampling a random variable for an actual equivalent initial flaw size (EIFS) comprises:
sampling a random variable from a distribution for a ratio of the actual EIFS to a reported EIFS, and multiplying this ratio by the reported EIFS to obtain a random variable for the actual EIFS,
wherein the distribution for a ratio of the actual EIFS to the reported EIFS is
$$f ( x \vert k , θ ) = \frac{{x}^{k - 1}}{Γ ( k ) {θ}^{k}} exp ( - \frac{x}{θ} ) ,$$
wherein x is the random variable for the ratio of the actual EIFS to the reported EIFS, k and θ are shape and scale parameters of the distribution, and Γ( ) is the Gamma function.

4. The method of claim 3, wherein k and θ are determined from a maximum likelihood estimator using data for the actual EIFS and the reported EIFS.

5. The method of claim 1, wherein sampling a random variable for an actual equivalent initial flaw size (EIFS) comprises:
sampling a random variable from a distribution for the actual EIFS, wherein the distribution for the actual EIFS is
$$f ( y ) = \frac{1}{\hat{a} Γ ( k ) {θ}^{k}} \frac{{y}^{k - 1}}{{\hat{a}}^{k - 1}} exp ( - \frac{y}{\hat{a} θ} ) ,$$
wherein y is the random variable for the actual EIFS, â is the random variable for a reported EIFS, k and θ are shape and scale parameters of the distribution determined from experimental data, and Γ( ) is the Gamma function.

6. The method of claim 1, wherein the fatigue crack growth equation is
$$\frac{d a}{d N} = {C ( Δ K )}^{m} ,$$
wherein a is a crack size, N is a number of load cycles, C and m are model parameters estimated from experimental data for which random variables are generated, and ΔK is a stress intensity factor range for one load cycle, wherein for an elliptically shaped crack, the stress intensity factor K of a point located at an angle λ with respect to a direction of an applied tensile stress σ is given by
$$K = M σ \sqrt{π a / Q} {( {sin}^{2} λ + {( \frac{a}{c} )}^{2} {cos}^{2} λ )}^{1 / 4} ,$$
wherein M is a location factor, a is the crack size and a minor axis length of the elliptically shaped crack and c is the major axis length of elliptically shaped crack,
$$Q = {Φ}^{2} - \frac{2}{3 π} ( \frac{σ}{{σ}_{ys}} )$$
is a flaw shape factor where
$$Φ = {\int }_{0}^{\frac{π}{2}} \sqrt{1 - ( \frac{{c}^{2} - {a}^{2}}{{c}^{2}} ) {sin}^{2} λ} d λ$$
is an elliptical integral of the second kind and σ_{ys} is material yield strength.

7. The method of claim 6, wherein the multivariate distribution is
$$p ( ln C , m , {σ}_{e} ) = \frac{1}{{σ}_{e}} {\prod }_{i = 1}^{n} \frac{1}{\sqrt{2 π} {σ}_{e}} exp [ - \frac{1}{2} {( \frac{ln C + m ln Δ {K}_{i} - {[ ln ( \frac{d a}{d N} ) ]}_{i}}{{σ}_{e}} )}^{2} ] ,$$
wherein σₑ is an error variable, and ln ΔKᵢ and [ln(da/dN)]ᵢ are i^{th} experimental data points from a total of n points.

8. The method of claim 3, wherein reported EIFS data is obtained by ultrasonically scanning a target object, recording echo signals from the target object, and converting echo signal amplitudes to equivalent reflector sizes using previously recorded values from a scanned calibration block, wherein the equivalent reflector sizes comprise the reported EIFS data.

9. A non-transitory program storage device readable by a computer, tangibly embodying a program of instructions executed by the computer to perform the method steps for probabilistically predicting fatigue life in materials, the method comprising the steps of:
sampling a random variable for an actual equivalent initial flaw size (EIFS);
generating random variables for parameters of a fatigue crack growth equation from a multivariate distribution; and
solving the fatigue crack growth equation using these random variables.

10. The computer readable program storage device of claim 9, the method further comprising repeating said steps of sampling a random variable for the EIFS, generating random variables for parameters and solving the fatigue crack growth equation until convergence.

11. The computer readable program storage device of claim 9, wherein sampling a random variable for an actual equivalent initial flaw size (EIFS) comprises:
sampling a random variable from a distribution for a ratio of the actual EIFS to a reported EIFS, and multiplying this ratio by the reported EIFS to obtain a random variable for the actual EIFS,
wherein the distribution for a ratio of the actual EIFS to the reported EIFS is
$$f ( x \vert k , θ ) = \frac{{x}^{k - 1}}{Γ ( k ) {θ}^{k}} exp ( - \frac{x}{θ} ) ,$$
wherein x is the random variable for the ratio of the actual EIFS to the reported EIFS, k and θ are shape and scale parameters of the distribution, and Γ( ) is the Gamma function.

12. The computer readable program storage device of claim 11, wherein k and θ are determined from a maximum likelihood estimator using data for the actual EIFS and the reported EIFS.

13. The computer readable program storage device of claim 9, wherein sampling a random variable for an actual equivalent initial flaw size (EIFS) comprises:
sampling a random variable from a distribution for the actual EIFS, wherein the distribution for the actual EIFS is
$$f ( y ) = \frac{1}{\hat{a} Γ ( k ) {θ}^{k}} \frac{{y}^{k - 1}}{{\hat{a}}^{k - 1}} exp ( - \frac{y}{\hat{a} θ} ) ,$$
wherein y is the random variable for the actual EIFS, â is the random variable for a reported EIFS, k and θ are shape and scale parameters of the distribution determined from experimental data, and Γ( ) is the Gamma function.

14. The computer readable program storage device of claim 9, wherein the fatigue crack growth equation is
$$\frac{d a}{d N} = {C ( Δ K )}^{m} ,$$
wherein a is a crack size, N is a number of load cycles, C and m are model parameters estimated from experimental data for which random variables are generated, and ΔK is a stress intensity factor range for one load cycle, wherein for an elliptically shaped crack, the stress intensity factor K of a point located at an angle λ with respect to a direction of an applied tensile stress σ is given by
$$K = M σ \sqrt{π a / Q} {( {sin}^{2} λ + {( \frac{a}{c} )}^{2} {cos}^{2} λ )}^{1 / 4} ,$$
wherein M is a location factor, a is the crack size and a minor axis length of the elliptically shaped crack and c is the major axis length of elliptically shaped crack,
$$Q = {Φ}^{2} - \frac{2}{3 π} ( \frac{σ}{{σ}_{ys}} )$$
is a flaw shape factor where
$$Φ = {\int }_{0}^{π / 2} \sqrt{1 - ( \frac{{c}^{2} - {a}^{2}}{{c}^{2}} ) {sin}^{2} λ} d λ$$
is an elliptical integral of the second kind and σ_{ys} is material yield strength.

15. The computer readable program storage device of claim 14, wherein the multivariate distribution is
$$p ( ln C , m , {σ}_{e} ) = \frac{1}{{σ}_{e}} {\prod }_{i = 1}^{n} \frac{1}{\sqrt{2 π} {σ}_{e}} exp [ - \frac{1}{2} {( \frac{ln C + m ln Δ {K}_{i} - {[ ln ( \frac{d a}{d N} ) ]}_{i}}{{σ}_{e}} )}^{2} ] ,$$
wherein σₑ is an error variable, and ln ΔKᵢ and [ln(da/dN)]ᵢ are i^{th} experimental data points from a total of n points.

16. The computer readable program storage device of claim 11, wherein reported EIFS data is obtained by ultrasonically scanning a target object, recording echo signals from the target object, and converting echo signal amplitudes to equivalent reflector sizes using previously recorded values from a scanned calibration block, wherein the equivalent reflector sizes comprise the reported EIFS data.

17. A system for probabilistically predicting fatigue life in materials, comprising:
an ultrasonic transducer; and
a control program of instructions in signal communication with the ultrasonic transducer and executable by a computer tangibly embodied in one or more computer readable program storage devices that perform the method steps for probabilistically predicting fatigue life in materials, the method comprising the steps of:
sampling a random variable for an actual equivalent initial flaw size (EIFS);
generating random variables for parameters of a fatigue crack growth equation from a multivariate distribution; and
solving the fatigue crack growth equation using these random variables.

18. The system of claim 17, wherein sampling a random variable for an actual equivalent initial flaw size (EIFS) comprises:
sampling a random variable from a distribution for a ratio of the actual EIFS to a reported EIFS, and multiplying this ratio by the reported EIFS to obtain a random variable for the actual EIFS,
wherein the distribution for a ratio of the actual EIFS to the reported EIFS is
$$f ( x \vert k , θ ) = \frac{{x}^{k - 1}}{Γ ( k ) {θ}^{k}} exp ( - \frac{x}{θ} ) ,$$
wherein x is the random variable for the ratio of the actual EIFS to the reported EIFS, k and θ are shape and scale parameters of the distribution, and Γ( ) is the Gamma function.

19. The system of claim 17, wherein sampling a random variable for an actual equivalent initial flaw size (EIFS) comprises:
sampling a random variable from a distribution for the actual EIFS, wherein the distribution for the actual EIFS is
$$f ( y ) = \frac{1}{\hat{a} Γ ( k ) {θ}^{k}} \frac{{y}^{k - 1}}{{\hat{a}}^{k - 1}} exp ( - \frac{y}{\hat{a} θ} ) ,$$
wherein y is the random variable for the actual EIFS, a is the random variable for a reported EIFS, k and θ are shape and scale parameters of the distribution determined from experimental data, and Γ( ) is the Gamma function.

20. The system of claim 17, wherein the fatigue crack growth equation is
$$\frac{d a}{d N} = {C ( Δ K )}^{m} ,$$
wherein a is a crack size, N is a number of load cycles, C and m are model parameters estimated from experimental data for which random variables are generated, and ΔK is a stress intensity factor range for one load cycle wherein for an elliptically shaped crack, the stress intensity factor K of a point located at an angle λ with respect to a direction of an applied tensile stress σ is given by
$$K = M σ \sqrt{π a / Q} {( {sin}^{2} λ + {( \frac{a}{c} )}^{2} {cos}^{2} λ )}^{1 / 4} ,$$
wherein M is a location factor, a is the crack size and a minor axis length of the elliptically shaped crack and c is the major axis length of elliptically shaped crack,
$$Q = {Φ}^{2} - \frac{2}{3 π} ( \frac{σ}{{σ}_{ys}} )$$
is a flaw shape factor where
$$Φ = {\int }_{0}^{π / 2} \sqrt{1 - ( \frac{{c}^{2} - {a}^{2}}{{c}^{2}} ) {sin}^{2} λ} d λ$$
is an elliptical integral of the second kind and σ_{ys} is material yield strength.

21. The system of claim 20, wherein the multivariate distribution is
$$p ( ln C , m , {σ}_{e} ) = \frac{1}{{σ}_{e}} {\prod }_{i = 1}^{n} \frac{1}{\sqrt{2 π} {σ}_{e}} exp [ - \frac{1}{2} {( \frac{ln C + m ln Δ {K}_{i} - {[ ln ( \frac{d a}{d N} ) ]}_{i}}{{σ}_{e}} )}^{2} ] ,$$
wherein σₑ is an error variable, and ln ΔKᵢ and [ln(da/dN)]ᵢ are i^{th} experimental data points from a total of n points.

22. The system of claim 17, wherein reported EIFS data is obtained by ultrasonically scanning a target object, recording echo signals from the target object, and converting echo signal amplitudes to equivalent reflector sizes using previously recorded values from a scanned calibration block, wherein the equivalent reflector sizes comprise the reported EIFS data.

23. The system of claim 17, further comprising a calibration block having a plurality of artificial reflectors, said calibration block configured for being scanned by said ultrasonic transducer, wherein the ultrasonic transducer records ultrasonic echo signals from the artificial reflectors and for comparison with echo signals recorded from the target object.
